(19) United States
(12) Patent Application Publication
(10) Pub. No.: US 2003/0016194 A1
(43) Pub. Date: Jan. 23, 2003

(54) Plasma display panel addressing

(76) Inventor: Jeroen Van Velzen, Eindhoven (NL)

Correspondence Address: U.S. Philips Corporation, 580 White Plains Road, Tarrytown, NY, 10591, US

(21) Appl. No.: 10/196,301

(22) Filed: Jul. 16, 2002

(30) Foreign Application Priority Data
Jul. 19, 2001 (EP) 01202772.8

(51) Int. Cl. G09G 3/28

(52) U.S. Cl. 345/60

(57) ABSTRACT

Method of selecting rows of a plasma display panel comprising: applying a voltage to a first row of cells in a plasma display panel during a first predetermined time period, applying a voltage to a second row of cells in a plasma display panel during a second predetermined time period, characterized in that the second time period partially overlaps the first time period by a preset overlap time period.

The overlap time period may correspond to the formative time lag, and may be around 0.5 μs.

The present invention relates to a method of selecting rows of a plasma display panel (PDP). The invention also relates to a display device comprising a PDP.

Pixels in a plasma display panel are formed by rows and columns of cells. Cells are addressed by selecting rows of the display sequentially, i.e. one row at a time, by the application of a scan voltage to the row. While a particular row is selected, each individual cell in that row can be addressed by applying data to the columns. In current PDP displays light is only generated for approximately one-third of the time, because the addressing requires the remaining two-third of the time.

It is an object of the invention to provide an addressing method, which requires less time. The invention is defined by the independent claims. The dependent claims define advantageous embodiments.

According to on aspect of the present invention there is provided a method of selecting rows of a plasma display panel comprising:

addressing a first row of cells in a plasma display panel during a first predetermined time period,

addressing a second row of cells in a plasma display panel during a second predetermined time period,

characterized in that

the second time period partially overlaps the first time period by a preset overlap time period.

Preferably the overlap time period corresponds to the formative time lag, i.e. to the time period required for the plasma cell to ignite, after a voltage is applied to the cell. Typically the formative time lag is around 0.1 to 5 μs, and more typically around 0.5 or 2 μs.

Thus if the overlap period is chosen to be the full length of the formative time lag, considerable savings can be made in the total addressing time, with a corresponding increase in the sustain time.

As an example typically the field period time is 16.6 ms. If the field period is split into 10 sub-fields, while the panel has 480 rows (VGA-resolution) and the pulse duration has a typical value of 2.5 μs per row, the total addressing time is 12 ms which leaves only about 4.6 ms in each field for light generation (approximately 28% of the total time). Assuming a formative time lag of 0.5 μs, then the maximum saving using the invention would be to achieved by reducing the row address pulse duration to 2 μs from 2.5 μs. This reduces the total addressing time to 9.6 ms. With the typical field address time of 16.6 ms this now allows 7 ms in each field for light generation, corresponding to approximately 42% of the total time. This equates to an increase of 50% in light generating time and thus of brightness.

According to a second aspect of the invention there is provided a display device comprising a plasma display panel. Such device is preferably comprising a clocked shift register and at least a first and a second OR gate having their inputs connected to respective adjacent pairs of outputs of the shift register so that the first OR gate generates the first row address signal, and the second OR gate generates the second row address signal overlapping the first by the preset overlap time period.

These and other aspects of the invention will be apparent from and elucidated with reference to the accompanying drawings, in which:

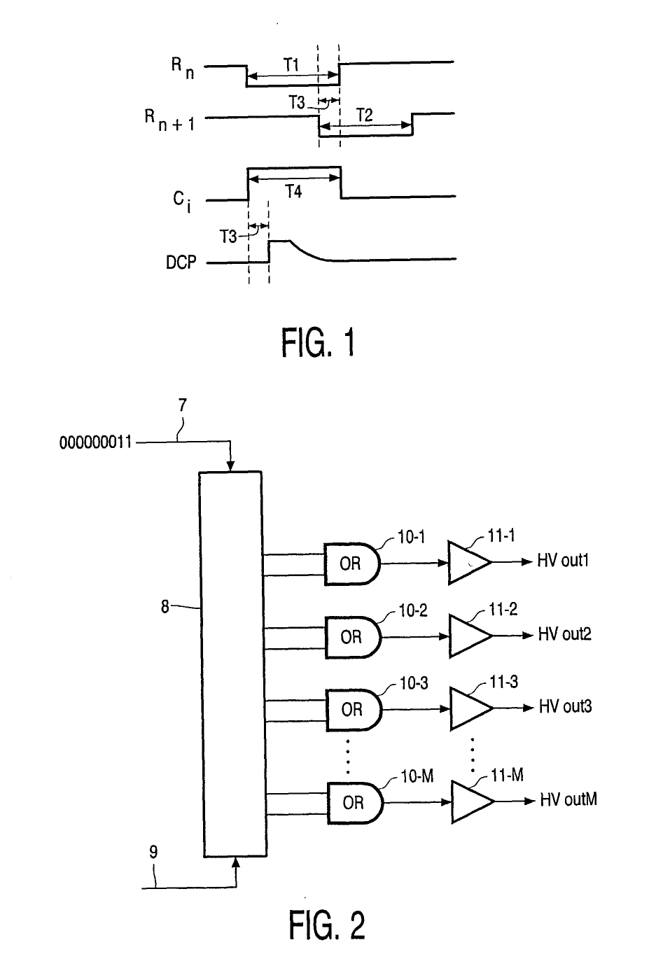

FIG. 1 illustrates the pulse duration in addressing rows and columns in a method according to the invention.

FIG. 2 is a circuit diagram of an embodiment of the scan part of a circuit for carrying out the method of the invention.

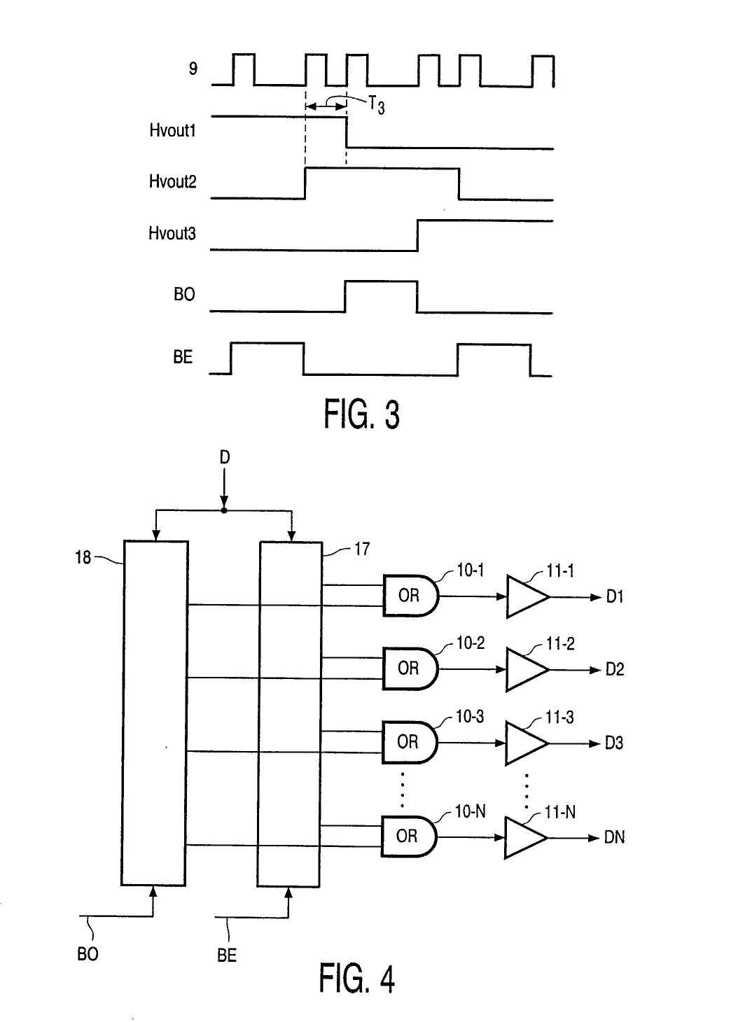

FIG. 3 is a timing diagram for the circuit of FIG. 2.

FIG. 4 is a circuit diagram of the embodiment of the data part of the circuit for carrying out the method of the invention.

In FIG. 1 a pulse T1 applied to row Rₙ is shown overlapping with pulse T2 applied to row Rₙ₊₁ by an amount T3 corresponding to the formative time lag of the cells of the PDP being driven. Column pulse T4 is applied to column Cᵢ and the discharge current pulse DCP is shown in the fourth line as delayed behind the leading edge of the column pulse T4 by an amount corresponding to the formative time lag T3.

The addressed cell n, identified at the junction of row Rₙ and column Cᵢ is set whereas the adjacent cell n+1 at the junction of row Rₙ₊₁ and column Cᵢ is not set. However the cell can still be controlled even though it is already selected.

In FIG. 2 the embodiment for effecting this time lag in the scan part of the circuit is shown.

A shift register 8 with a clock input 9 receives and shifts a shift input 7 consisting of an “11” pattern of binary digits. Adjacent outputs of the shift register 8 are connected in pairs to respective OR gates 10-1, 10-2, 10-3 up to 10-M and each OR gate is connected via a respective buffer 11-1, 11-2, 11-3 up to 11-M to a respective output Hvout1, Hvout2, Hvout3 up to HvoutM, where M is the number of rows of the panel.

The OR gates and buffers can be integrated in a scan IC. The outputs Hvout1 to HvoutM are connected to the rows of the panel for selecting the lines to be addressed.

The timing diagram for this is shown in FIG. 3 and will be self-explanatory to a skilled person in the field. It can easily be seen that adjacent outputs Hvout overlap by a predetermined amount, in this example, by one clock period T3.

In FIG. 4 the embodiment of the data part is shown. Here data D related to odd lines are stored in a first data memory 18 while data D related to even lines are stored in a second data memory 17. The data memories comprise all data of two consecutive lines, in synchronization with the lines selected by the scan part of the circuit. Pairs of equivalent outputs of each of the two memories 18, 17 are connected to respective OR gates 10-1, 10-2, 10-3, up to 10-N, where N is the number of pixels in a row. The data outputs D1, D2, D3 up to DN are connected to the columns of the panel.

The data outputs of consecutive lines should overlap at the same moments that actually two rows are selected by the scan part of the circuit (during the time T3 as shown in FIG. 1). In that way the data outputs D1 . . . DN supplied to the columns of the plasma display are synchronized with the time shift T3. This can be achieved by proper timing of the blanking signals BO, BE of respective memories 18, 17 as is shown in FIG. 3, indicated by the signals BO and BE. Each new line of data will be stored successively in one of the two line memories 18, 17. New data should be stored in the memories while the blanking signal BO, BE are active. Data in the memories 18, 17 should be stable when the blanking signals are non-active.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of selecting rows of a plasma display panel, the method comprising:
addressing a first row of cells in a plasma display panel during a first predetermined time period,
addressing a second row of cells in a plasma display panel during a second predetermined time period,
characterized in that
the second time period partially overlaps the first time period by a preset overlap time period.

2. A method according to claim 1 wherein the overlap time period corresponds to the formative time lag.

3. A method according to claim 2 wherein the overlap time period is around 0.1 to 5 μs.

4. A method according to claim 3 wherein the overlap time period is around 0.5 μs.

5. A method according to claim 3, wherein the overlap time period is around 2 μs.

6. A display device comprising
a plasma display panel comprising a matrix of rows and columns of cells;
means for addressing a first row during a first predetermined period and addressing a second row during a second predetermined period; and
means for supplying data to the columns,
characterized in that the second period partially overlaps the first time period by a present overlap period, and the means for supplying data are adapted to supply data to the columns in synchronization with the first and second time periods.

7. A display device according to claim 6, wherein the means for addressing comprise a shift register and OR-gates, pairs of outputs of the shift register are coupled to OR gates, and each row is coupled to an output of an OR-gate.

8. A display device according to claim 6, wherein OR-gates are present and the means for supplying data comprise a first and a second line memory, equivalent outputs of which are coupled as pairs to inputs of the OR-gates, and outputs of the OR-gates are coupled to the columns.
